(19) United States
(12) Patent Application Publication
(10) Pub. No.: US 2008/0010326 A1
(43) Pub. Date: Jan. 10, 2008

(54) Method and system for securely deleting files from a computer storage device

(76) Inventors: Troy A. Carpenter, Erie, CO (US); Tony Nichols, Erie, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/454,097

(22) Filed: Jun. 15, 2006

(51) Int. Cl. G06F 17/30

(52) U.S. Cl. 707/205

(57) ABSTRACT

A method and system for securely deleting files from a computer storage device is described. One embodiment locates a data structure associated with a file to be deleted; locates, using information contained in the data structure, the set of data storage units in which the file resides; and overwrites with a data pattern at least once each data storage unit in the set of data storage units, the overwriting being performed using direct drive access, the direct drive access bypassing standard file Application Program Interface (API) function calls of the operating system of the computer.

### RELATED APPLICATIONS

The present application is related to the following commonly owned and assigned applications: U.S. application Ser. No. 11/145,593, Attorney Docket No. WEBR-009/00US, entitled “System and Method for Neutralizing Locked Pestware Files”; and U.S. application Ser. No. 11/237,575, Attorney Docket No. WEBR-025/00US, entitled “System and Method for Removing Residual Data From Memory”; both of which are incorporated herein by reference.

### FIELD OF THE INVENTION

The present invention relates generally to managing data on a computer storage device. In particular, but not by way of limitation, the present invention relates to techniques for securely deleting files from such a storage device.

### BACKGROUND OF THE INVENTION

Many computer users are aware that files “deleted” from a computer storage device (e.g., a disk drive) are not immediately removed from the storage device. Rather, the space they occupy is returned to a pool of available space, and the “deleted’ files remain recoverable through, for example, “un-erase” utility software until the operating system eventually overwrites their data with data belonging to other files.

Computer users sometimes desire to delete data from their systems in a manner that renders the data unrecoverable by even the most sophisticated hacker. The need may arise, for example, where sensitive data (e.g., Social Security numbers or credit card numbers) have been stored on the computer's hard disk drive and the user intends to sell or otherwise dispose of the computer. The need may also arise in the context of securely and permanently removing malware or pestware files from the system so that they cannot be recovered and reactivated by other malware or pestware. There are a variety of other situations and motivations necessitating the secure deletion of files from a computer storage device.

Some conventional software utilities render files unrecoverable by overwriting their data with random or other data patterns such as those defined in the Department of Defense 5022-22M erasure algorithm. To ensure the data cannot be recovered, overwriting of the data is often repeated multiple times, and more than one data pattern can be used. However, these conventional utilities use standard file Application Program Interfaces (APIs) of the operating system to overwrite the data. This approach has disadvantages. First, since the operating system can detect that the data is being deleted, it is possible for the operating system or some other application to keep a log, cache, or other secondary record of the data that could later be recovered. Secondly, a process (e.g., malware) might intercept or interfere with the standard file APIs used to overwrite the data, thereby preventing secure deletion of the data. Finally, a file might use the operating system to protect or “lock” itself, preventing removal.

It is thus apparent that there is a need in the art for an improved method and system for securely deleting files from a computer storage device.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for securely deleting files from a computer storage device. One illustrative embodiment is a method for securely deleting a file from computer storage device, comprising locating a data structure associated with the file, the file being contained in a set of data storage units on the storage device; locating, using information contained in the data structure, the set of data storage units; and overwriting with a data pattern at least once each data storage unit in the set of data storage units, the overwriting being performed using direct drive access, the direct drive access bypassing standard file Application Program Interface (API) function calls of an operating system of the computer.

Another illustrative embodiment is a system for securely deleting a file from a computer storage device, comprising a data location module configured to locate a data structure associated with the file, the file being contained in a set of data storage units on the storage device, and to locate, using information contained in the data structure, the set of data storage units; and a secure data overwrite module configured to overwrite with a data pattern at least once each data storage unit in the set of data storage units using direct drive access, the direct drive access bypassing standard file Application Program Interface (API) function calls of an operating system of the computer. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1A is a functional block diagram of a computer equipped with a system for securely deleting files from a storage device of the computer, in accordance with an illustrative embodiment of the invention;

FIG. 1B is a diagram of a memory of the computer shown in FIG. 1A, in accordance with an illustrative embodiment of the invention;

FIG. 2 is a flowchart of a method for securely deleting a file from a computer storage device, in accordance with an illustrative embodiment of the invention; and

FIG. 3 is a flowchart of a method for securely deleting a file from a computer storage device, in accordance with another illustrative embodiment of the invention.

### DETAILED DESCRIPTION

In one illustrative embodiment, the data associated with a file to be deleted securely from a computer storage device is overwritten with a data pattern at least once using direct drive access, the direct drive access bypassing the standard file Application Program Interface (API) function calls of an operating system of the computer. The directory entry associated with the file may also be overwritten with a data pattern at least once using direct drive access (or, optionally, using standard file API function calls) to remove all evidence that the file ever existed. In some embodiments, a user is given a choice between conventional (non-secure) data overwriting using file API function calls of the operating system and secure data overwriting using direct-drive-access APIs. The principles of the invention may be applied to any file system, including, without limitation, New Technology File System (NTFS) and File Allocation Table (FAT) file systems.

A formatted computer storage medium (e.g., a hard disk) is typically divided into data storage units called “clusters,” each of which is usually a power-of-two multiple of a smaller 512-byte-long unit called a “sector.” The operating system generally operates at the granularity of a cluster, meaning a cluster is the smallest data storage unit the operating system manipulates.

As used herein, “a direct drive access” is an input/output (I/O) operation between a process running on a computer and a connected storage device that is conducted at the sector (physical) level rather than at the file (logical) level. “Direct drive access” is also used herein to refer to direct, sector-level I/O in general, as opposed to file-level I/O. When a process uses direct drive access to read from or write to a storage device, it is responsible for many details that the operating system normally handles when standard file APIs are used. For example, operating systems sold by Microsoft Corporation under the trade name WINDOWS (e.g., WINDOWS XP) require a process employing direct drive access to perform disk I/O in terms of sector-aligned blocks of bytes at the granularity of a cluster.

Using direct drive access to overwrite the data to be obliterated, though more complex, has several advantages over using the standard file APIs of the operating system. Since direct drive access substantially circumvents the operating system of the computer, files can be securely deleted without the operating system being aware of it. This prevents the operating system from logging or caching the data to be removed, which could render it recoverable. It also prevents processes (e.g., malware or pestware) that might interfere with or intercept standard file APIs from thwarting the overwriting of the data. Also, anti-virus programs that monitor suspicious activity on a computer may be falsely triggered by the conventional approach of overwriting the data using standard file APIS. Overwriting the data using direct drive access avoids unnecessarily alerting anti-virus software.

“Pestware,” as used herein, refers to any program that damages or disrupts a computer system or that collects or reports information about a person or an organization. Examples include, without limitation, viruses, worms, Trojan horses, spyware, adware, and downloaders. In some situations, a file requiring secure removal is associated with pestware (e.g., a pestware executable object).

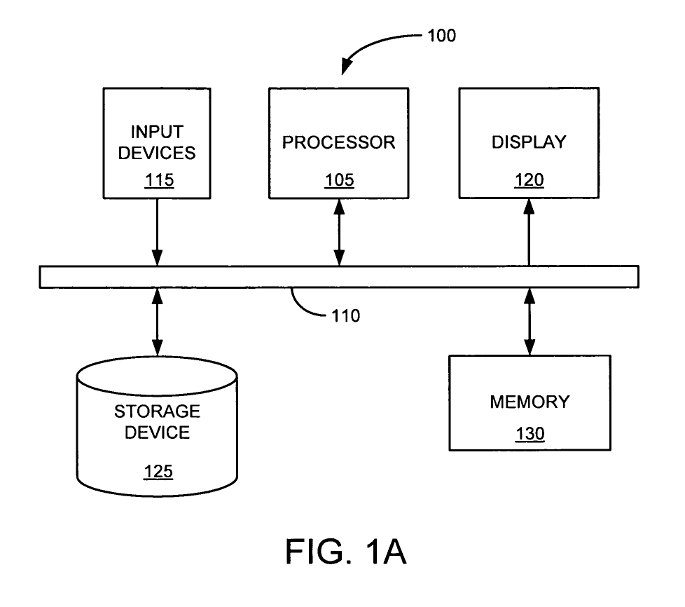

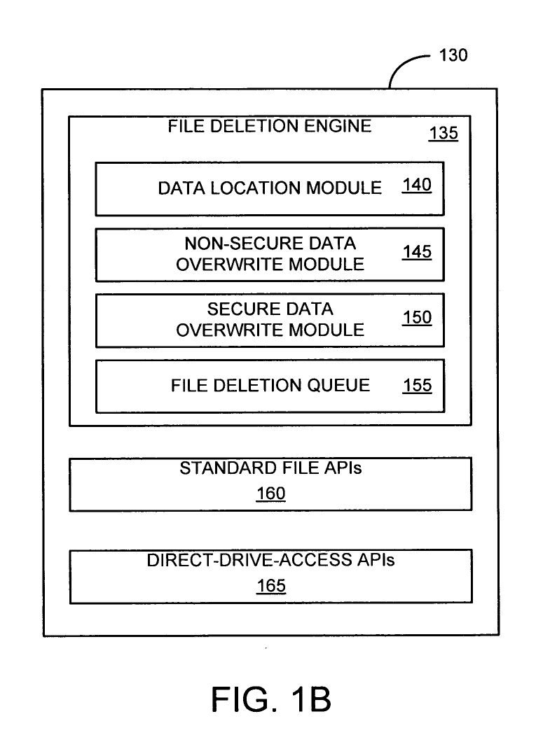

Referring now to the drawings, where like or similar elements are designated with identical reference numerals throughout the several views, and referring in particular to FIG. 1A, it is a functional block diagram of a computer 100 equipped with a system for securely deleting files from a storage device of the computer, in accordance with an illustrative embodiment of the invention. Computer 100 can be a desktop computer, workstation, laptop computer, notebook computer, handheld computer, or any other device that includes computing functionality. In FIG. 1A, processor 105 communicates over data bus 110 with input devices 115, display 120, storage device 125, and memory 130.

Input devices 115 may be, for example, a keyboard and a mouse or other pointing device. In an illustrative embodiment, storage device 125 is a magnetic-disk device such as a hard disk drive (HDD) that stores directories (or folders) and files. In other embodiments, however, storage device 125 can be any type of computer storage device (“drive”), including, without limitation, a magnetic-disk drive, an optical-disc drive, and a storage device employing flash-memory-based media such as secure digital (SD) cards or multi-media cards (MMCs). Memory 130 may include random-access memory (RAM), read-only memory (ROM), or a combination thereof.

FIG. 1B is a diagram of memory 130 of computer 100 shown in FIG. 1A, in accordance with an illustrative embodiment of the invention. Memory 130 includes file deletion engine 135, a system for securely deleting files from storage device 125. For convenience in this Detailed Description, the functionality of file deletion engine 135 has been divided into several components, including, in this illustrative embodiment, data location module 140, non-secure data overwrite module 145, secure data overwrite module 150, and file deletion queue 155. In various embodiments of the invention, the functionality of these parts can be combined or subdivided in ways other than that indicated in FIG. 1B. Also, not all of these components are included in every embodiment of the invention.

In the illustrative embodiment of FIG. 1B, file deletion engine 135 is an application program stored on a computer-readable storage medium of computer 100 (e.g., storage device 125) that can be loaded into memory 130 and executed by processor 105. In other embodiments, the functionality of file deletion engine 135 can be implemented in software, firmware, hardware, or any combination thereof.

Memory 130 also includes a set of standard file APIs 160 and at least one direct-drive-access API 165. In WINDOWS operating systems, one such direct-drive-access API 165 is “CreateFile( ).”

Data location module 140 is configured to locate, on storage device 125, the data making up a file that is to be removed from storage device 125. Data location module 140 can do so, for example, by locating a file-system data structure such as a Master File Table (MFT) or File Allocation Table (FAT) entry associated with the file. The former applies to NTFS file systems; the latter, to FAT file systems. The invention is not confined, however, to these two file systems. Those skilled in the art will recognized that the principles of the invention can be applied to any file system. By consulting the associated file-system data structure, data location module 140 can locate the set of data storage units (e.g., sectors) the file occupies on storage device 125. Additional information concerning the locating of the file-system data structure associated with a file and the set of data storage units the file occupies can be found in U.S. application Ser. No. 11/145,593, Attorney Docket No. WEBR-009/00US, entitled “System and Method for Neutralizing Locked Pestware Files,” cited above under Related Applications.

Non-secure data overwrite module 145 is configured to overwrite the data located by data location module 140 at least once using standard file APIs 160. In doing so, non-secure data overwrite module 145 may overwrite the data with any of a variety of data patterns (random, alternating ones and zeroes, Department of Defense, or other industry-standard patterns) or with a combination of different data patterns through multiple overwrites.

Non-secure data overwrite module 145 is termed “non-secure” because it uses standard file APIs of the operating system to overwrite the data, an approach that is vulnerable in the ways explained above. More information about the overwriting of data and the various data patterns with which data can be overwritten is found in U.S. application Ser. No. 11/237,575, Attorney Docket No. WEBR-025/00US, entitled “System and Method for Removing Residual Data From Memory,” cited above under Related Applications.

Secure data overwrite module 150 is configured to overwrite the data located by data location module 140 at least once using direct-drive-access APIs 165. In doing so, secure data overwrite module 150 may overwrite the data with any of a variety of data patterns (random, alternating ones and zeroes, Department of Defense, or other industry-standard patterns) or with a combination of different data patterns through multiple overwrites. Secure data overwrite module 150 can also overwrite with a data pattern at least once the directory entry associated with each file that is securely deleted to render the file completely unrecoverable. More information about the overwriting of directory entries is found in U.S. application Ser. No. 11/237,575, Attorney Docket No. WEBR-025/00US, entitled “System and Method for Removing Residual Data From Memory,” cited above under Related Applications.

File deletion queue 155 is a list of one or more files to be deleted from storage device 125, whether immediately or in the future. File deletion queue 155, in the illustrative embodiment of FIG. 1B, resides in a data portion of memory 130. Files can be added to file deletion queue 155 automatically by file deletion engine 135 or another application, or they can be added manually by a user of computer 100.

In the illustrative embodiment shown in FIG. 1B, a user of computer 100 is given a choice between secure and non-secure file removal. For example, non-secure data overwrite module 145 can be made operative when a non-secure deletion mode of file deletion engine 135 is selected, and secure data overwrite module 150 can be made operative when a secure deletion mode of file deletion engine 135 is selected. The user's preference for secure or non-secure file deletion can be stored by file deletion engine 135 and applied automatically until the user changes the preference.

In other embodiments of the invention, file deletion engine 135 is configured somewhat differently. For example, in some embodiments file deletion engine 135 does not include non-secure data overwrite module 145. In such embodiments, all overwriting of file data and directory entries is performed using direct drive access APIs 165.

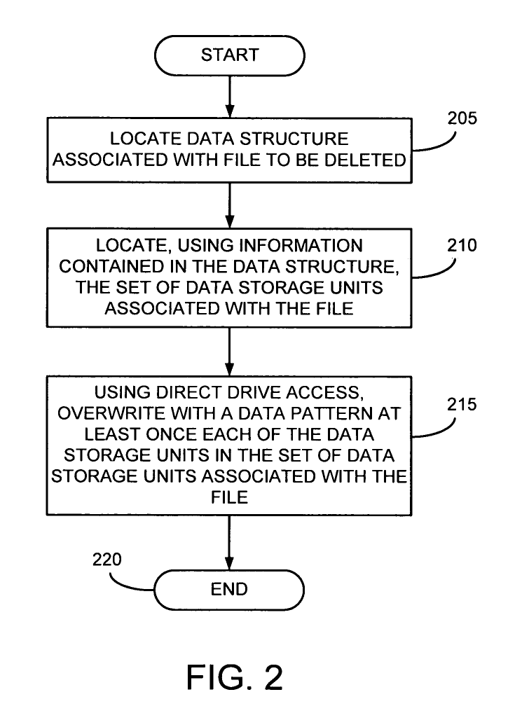

FIG. 2 is a flowchart of a method for securely deleting a file from a computer storage device 125, in accordance with an illustrative embodiment of the invention. At 205, data location module 140 locates a file-system data structure associated with a file to be deleted. As explained above, the data structure may be, for example, an MFT or FAT entry. Using information contained in the data structure found at 205, data location module 140 locates the set of data storage units (e.g., sectors) associated with the file at 210. At 215, secure data overwrite module 150 overwrites, with a data pattern at least once, each of the data storage units in the set of data storage units located at 210. In doing so, secure data overwrite module 150 employs direct-drive-access APIs 165, as explained above. Optionally, secure data overwrite module 150 may also overwrite, with a data pattern at least once using direct-drive-access APIs 165, the directory entry associated with the file. At 220, the process terminates. Those skilled in the art will recognize that the method shown in FIG. 2 can be repeated for any number of files that are to be removed from storage device 125.

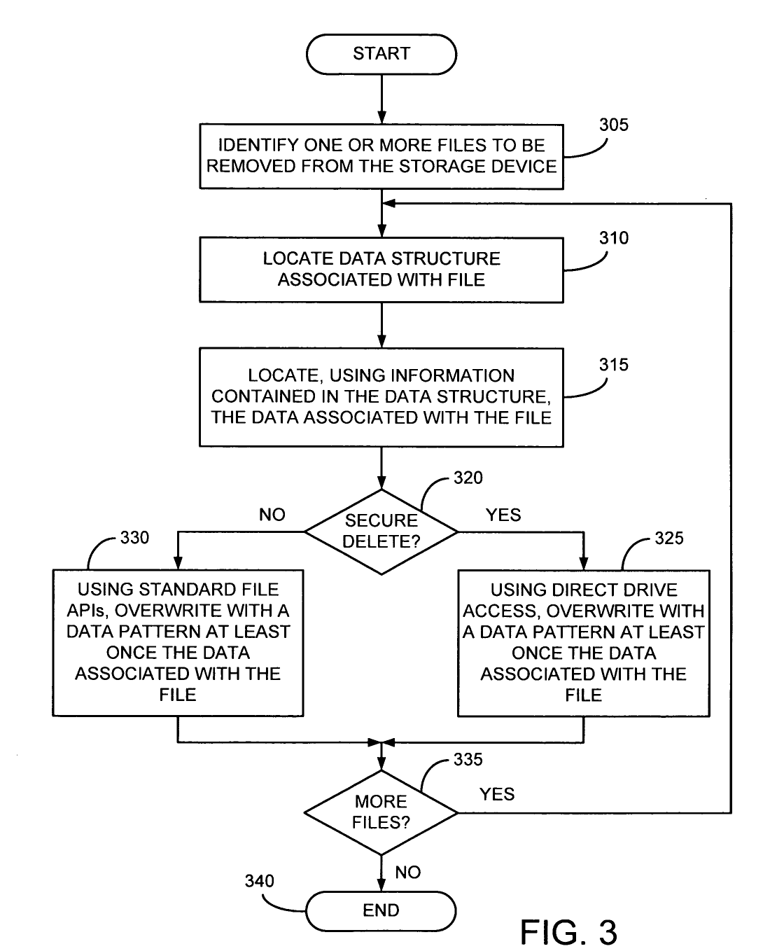

FIG. 3 is a flowchart of a method for securely deleting a file from a computer storage device 125, in accordance with another illustrative embodiment of the invention. At 305, file deletion engine 135 identifies one or more files to be removed from storage device 125 and stores references to them in file deletion queue 155. File deletion engine 135 then performs Blocks 310, 315, and 320 for each file identified at 305. At 310, data location module 140 locates a file-system data structure associated with the next file to be removed. As explained above, the data structure may be, for example, an MFT or FAT entry. Using information contained in the data structure found at 310, data location module 140 locates, at 315, the data constituting the file. If secure file deletion is selected at 320, secure data overwrite module 150, at 325, overwrites, with a data pattern at least once using direct-drive-access APIs 165, the data located at 315. Otherwise, if non-secure file deletion is selected at 320, non-secure data overwrite module 145, at 330, overwrites, with a data pattern at least once using standard file APIs 160, the data located at 315. Optionally, secure data overwrite module 150 or non-secure data overwrite module 145, depending on the deletion mode selected, may also overwrite, with a data pattern at least once, the directory entry associated with the file. When all files to be removed from storage device 125 have been processed at 335, the process terminates at 340.

In conclusion, the present invention provides, among other things, a method and system for securely deleting files from a computer storage device. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, though the WINDOWS operating system was mentioned above as a possible environment in which the invention can be implemented, the principles of the invention can be applied to LINUX or other operating systems.

What is claimed is:

1. A method for securely deleting a file from a storage device of a computer, the method comprising:
locating a data structure associated with the file, the file being contained in a set of data storage units on the storage device;
locating, using information contained in the data structure, the set of data storage units; and
overwriting with a data pattern at least once each data storage unit in the set of data storage units, the overwriting being performed using direct drive access, the direct drive access bypassing standard file Application Program Interface (API) function calls of an operating system of the computer.

2. The method of claim 1, further comprising:
overwriting with a data pattern at least once a directory entry associated with the file using direct drive access, the direct drive access bypassing the standard file Application Program Interface (API) function calls of the operating system.

3. The method of claim 1, wherein the data structure associated with the file is one of an entry in a Master File Table (MFT) associated with a New Technology File System (NTFS) and an entry in a File Allocation Table (FAT) associated with a FAT file system.

4. The method of claim 1, wherein each data storage unit in the set of data storage units is a sector.

5. A method for removing files from a storage device of a computer, the method comprising:
identifying at least one file to be removed from the storage device, each of the at least one file having associated data; and
performing the following for each of the at least one file:
locating a data structure associated with the file;
locating, using information contained in the data structure, the data associated with the file;
overwriting with a data pattern at least once the data associated with the file using standard file Application Program Interface (API) function calls of an operating system of the computer, when a first file removal mode is selected; and
overwriting with a data pattern at least once the data associated with the file using direct drive access, when a second file removal mode is selected, the direct drive access bypassing the standard file Application Program Interface (API) function calls of the operating system.

6. The method of claim 5, further comprising:
overwriting with a data pattern at least once a directory entry associated with the file using direct drive access, when the second file removal mode is selected, the direct drive access bypassing the standard file Application Program Interface (API) function calls of the operating system.

7. The method of claim 5, wherein the data structure associated with the file is one of an entry in a Master File Table (MFT) associated with a New Technology File System (NTFS) and an entry in a File Allocation Table (FAT) associated with a FAT file system.

8. A system for securely deleting a file from a storage device of a computer, the system comprising:
a data location module configured to:
locate a data structure associated with the file, the file being contained in a set of data storage units on the storage device; and
locate, using information contained in the data structure, the set of data storage units; and
a secure data overwrite module configured to overwrite with a data pattern at least once each data storage unit in the set of data storage units using direct drive access, the direct drive access bypassing standard file Application Program Interface (API) function calls of an operating system of the computer.

9. The system of claim 8, wherein the secure data overwrite module is further configured to overwrite with a data pattern at least once a directory entry associated with the file using direct drive access, the direct drive access bypassing the standard file Application Program Interface (API) function calls of the operating system.

10. The system of claim 8, wherein the data structure associated with the file is one of an entry in a Master File Table (MFT) associated with a New Technology File System (NTFS) and an entry in a File Allocation Table (FAT) associated with a FAT file system.

11. The system of claim 8, wherein each data storage unit in the set of data storage units is a sector.

12. A system for removing files from a storage device of a computer, the system comprising:
a file deletion queue including at least one file to be removed from the storage device;
a data location module configured to:
locate, for each of the at least one file, a data structure associated with that file; and
locate, for each of the at least one file, data constituting that file using information contained in the data structure associated with that file;
a non-secure data overwrite module configured, for each of the at least one file, to overwrite with a data pattern at least once the data constituting that file using standard file Application Program Interface (API) function calls of an operating system of the computer, when a non-secure file removal mode is selected; and
a secure data overwrite module configured, for each of the at least one file, to overwrite with a data pattern at least once the data constituting that file using direct drive access, when a secure file removal mode is selected, the direct drive access bypassing the standard file Application Program Interface (API) function calls of the operating system.

13. The system of claim 12, wherein the secure data overwrite module is further configured, for each of the at least one file, to overwrite with a data pattern at least once a directory entry associated with that file using direct drive access, when the secure file removal mode is selected, the direct drive access bypassing the standard file Application Program Interface (API) function calls of the operating system.

14. The system of claim 12, wherein the data structure associated with each of the at least one file is one of an entry in a Master File Table (MFT) associated with a New Technology File System (NTFS) and an entry in a File Allocation Table (FAT) associated with a FAT file system.

15. A system for securely deleting a file from a storage device of a computer, the system comprising:
means for locating a data structure associated with the file, the file being contained in a set of data storage units on the storage device;
means for locating, using information contained in the data structure, the set of data storage units; and
means for overwriting with a data pattern at least once each data storage unit in the set of data storage units, the overwriting being performed using direct drive access, the direct drive access bypassing standard file Application Program Interface (API) function calls of an operating system of the computer.

16. A system for removing files from a storage device of a computer, the system comprising:
means for identifying at least one file to be removed from the storage device;
means for locating, for each of the at least one file, a data structure associated with that file;
means for locating, for each of the at least one file, data constituting that file using information contained in the data structure associated with that file;
means, operative upon each of the at least one file, for overwriting with a data pattern at least once the data constituting that file using standard file Application Program Interface (API) function calls of an operating system of the computer, when a non-secure file removal mode is selected; and
means, operative upon each of the at least one file, for overwriting with a data pattern at least once the data constituting that file using direct drive access, when a secure file removal mode is selected, the direct drive access bypassing the standard file Application Program Interface (API) function calls of the operating system.

17. A computer-readable storage medium having program instructions executable by a processor to delete securely a file from a storage device of a computer, the program instructions comprising:
a first instruction segment configured to locate a data structure associated with the file, the file being contained in a set of data storage units on the storage device;
a second instruction segment configured to locate, using information contained in the data structure, the set of data storage units; and
a third instruction segment configured to overwrite with a data pattern at least once each data storage unit in the set of data storage units using direct drive access, the direct drive access bypassing standard file Application Program Interface (API) function calls of an operating system of the computer.

18. A computer-readable storage medium having program instructions executable by a processor to remove files from a storage device of a computer, the program instructions comprising:
a first code segment configured to identify at least one file to be removed from the storage device, each of the at least one file having associated data; and
a second code segment configured, for each of the at least one file, to:
locate a data structure associated with the file;
locate, using information contained in the data structure, the data associated with the file;
overwrite with a data pattern at least once the data associated with the file using standard file Application Program Interface (API) function calls of an operating system of the computer, when a first file removal mode is selected; and
overwrite with a data pattern at least once the data associated with the file using direct drive access, when a second file removal mode is selected, the direct drive access bypassing the standard file Application Program Interface (API) function calls of the operating system.
